(19) United States
(12) Patent Application Publication
(10) Pub. No.: US 2005/0161277 A1
(43) Pub. Date: Jul. 28, 2005

(54) Steering gear is free from backlash

(76) Inventors: Michael Bock, REMSECK/HOCHDORF (DE); Willie Nagel, Remseck/Hochdorf (DE); Peter Brenner, Moegglingen (DE)

Correspondence Address: Anthony Niewyk;Baker & Daniels, 111 East Wayne Street, Suite 800, Fort Wayne, IN, 46802, US

(21) Appl. No.: 10/506,854

(22) PCT Filed: Mar. 25, 2003
(86) PCT No.: PCT/DE03/00970

(30) Foreign Application Priority Data
Apr. 17, 2002 (DE) 102 17 123.8

(51) Int. Cl. B62D 5/04

(52) U.S. Cl. 180/400; 74/425; 74/409

(57) ABSTRACT

A worm gear for a vehicle steering system. The worm gear includes a tooth worm and a tooth worm wheel which mesh with each other. The teeth on the worm wheel are shaped such that the pressure angle of the left tooth flank and the right tooth flank are different from each other so that the normal force between the worm and the worm wheel is independent of the direction of rotation of the torque exerted on the worm by the worm wheel.

### BACKGROUND OF THE INVENTION

The invention concerns a worm gear for a vehicle steering system comprising a worm disposed in a rotationally fixed manner on a shaft and a worm wheel meshing with the worm, said worm and said worm wheel being preloaded in the radial direction.

Conventional vehicle steering systems, vehicle steering systems equipped with speed modulation gears or superposition gears and steer-by-wire steering systems, require one or more steering gears to convert the rotary motion of the steering wheel into rotary motion of the steered wheels.

In conventional electric servo steering systems, a torque applied by an electric motor also has to be coupled into the steering. In a steer-by-wire steering system, there is no mechanical or hydraulic connection between the steering wheel and the steered wheels. A steering actuator regulates the position of the steered wheels as a function of the driver's steering input and other factors, such as yaw rate or road speed, for example. The steering movement of the steered wheels is freely programmable, and all of the steering work is applied by the electrical or hydraulic steering actuator.

In vehicle steering systems equipped with speed modulation gears, a conventional steering system is combined with a speed modulation gear so that steering interventions can be carried out regardless of driver input. The characteristics of a steer-by-wire steering system are thus, by and large, obtained. Backlash is undesirable with these speed modulation gears, since it detracts from steering feel, lowers the precision of steering interventions and also makes itself perceptible in annoying fashion in the form of a “snapping sound” that occurs when the direction of rotation is changed.

Worm gears with an electric motor are often used for the above-cited purposes, since they are usually self-inhibiting and the electric motor can therefore be switched off when the worm gear is not meant to be rotating.

Known from the unpublished German patent application number DE 100 51 506.9 (filing date Oct. 17, 2000) of Robert Bosch GmbH is a gear assembly for a vehicle steering system in which the shaft to which the worm of a worm gear is fastened is mounted so as to be able to swivel in the radial direction. One of the two bearings is displaceable in the radial direction. The application of a spring force in the radial direction causes the shaft to swivel on a fixed bearing, thus ensuring zero-backlash meshing of the worm with the worm wheel.

When the electric drive of the worm gear is not being driven, the worm gear should be self-inhibiting so that the steering movements are transmitted directly and unchanged from the steering wheel to the steered wheels.

### SUMMARY OF THE INVENTION

In a worm gear according to the invention, the self-inhibition of the worm gear is independent of the orientation of a torque acting on the worm wheel when the electric motor is switched off. The behavior of the worm gear is therefore independent of the direction of rotation even when the electric motor is not drawing current.

This increases the reliability of a vehicle steering system equipped with a worm gear according to the invention, in particular even when the electric motor or a control unit is out of commission. This advantage is very significant, since steering systems must be operational even when parts of the vehicle's electrical system fail.

In a variant of the invention, the shaft is mounted in a housing by means of a fixed bearing and at least one loose bearing, and that the loose bearing or bearings are displaceable in the housing in the radial direction, and/or that the housing comprises a slot for receiving the loose bearing, and that the longitudinal axis of the slot extends in the radial direction. In this variant, the swiveling movement of the shaft is governed by the slot. It is impossible for the shaft to slip tangentially. Furthermore, in production engineering terms, a slot is easy to fabricate. In a further complement to the invention, the loose bearing bears against the housing via a support ring and thus the loose bearing is not subjected to linear radial loads and the guidance of the loose bearing in the housing is improved.

In a further complement to the invention, at least one spring element, particularly a spiral spring or a plate spring, is provided between the loose bearing and the housing or between the support ring and the housing, making it possible in a simple and cost-effective manner to establish a defined preload between the worm and the worm wheel or toothed rack. The preload force basically depends on the spring rate of the spring element or elements and only to a small extent on the production tolerance of the support ring and the housing.

In a particularly advantageous embodiment of the invention, the loose bearing is connected via a leaf spring to the housing and the leaf spring extends perpendicularly to the longitudinal axis of the shaft and perpendicularly to the direction in which the loose bearing is displaceable between the housing and the loose bearing. The leaf spring is fastened to the housing in such fashion as to achieve the desired pressure force between the worm and the worm wheel. The number of components is reduced in this embodiment, since the leaf spring acts both as a spring and as a guide. The embodiment is also very easy to install.

In another embodiment of the invention, an anti-twist device is mounted between the loose bearing and the housing or between the support ring and the housing to keep the loose bearing from rotating in the housing, which could adversely affect operation.

In a further complement to the invention, the worm is disposed in a rotationally fixed manner on the rotor shaft of an electric motor, thus reducing the number of components and permitting particularly compact construction for the gear according to the invention.

To minimize the effects on the operability and operating behavior of the vehicle steering system due to a loss of self-inhibition potentially occurring in extreme cases, it is further provided to lock the worm gear via the electric motor. This locking of the worm gear can be achieved either actively, by the development of a countertorque in the electric motor, or passively, by short-circuiting at least two phases of the electric motor. The passive locking is effected by short-circuiting at least two phases of the electric motor and disconnecting them from the voltage supply when the electric motor is not meant to be turning. If the electric motor is driven in this condition despite the self-inhibition of the worm gear, the electric motor develops a braking torque due to the short-circuited phases. This greatly reduces the undesired rotary motion.

This passive locking is advantageously effected by short-circuiting at least two phases of the electric motor by means of a relay or by means of FET semiconductor elements.

The active and passive locking of the worm gear can also be used with other electrical drives, preferably comprising speed modulation gears, regardless of the asymmetrical toothing of the invention.

Finally, the gear according to the invention can be used in a servo unit of an electrical servo steering system, in a rack-and-pinion steering gear, in a steering actuator with a speed modulation gear, or as the electromotive steering actuator of a steer-by-wire steering system.

Further advantages and advantageous embodiments of the invention will become apparent from the following drawing and accompanying description.

### BRIEF DESCRIPTION OF THE DRAWINGS

Exemplary embodiments of the invention are depicted in the drawings and described hereinbelow, wherein:

FIG. 1 shows a first exemplary embodiment of a worm gear according to the invention with external toothing;

FIG. 2 shows a second exemplary embodiment of a worm gear according to the invention;

FIG. 3 shows a detail of a first embodiment of a shaft mounting according to the invention; and

FIG. 4 shows a detail of a second embodiment of a shaft mounting according to the invention.

### DESCRIPTION OF THE PREFERRED EMBODIMENTS

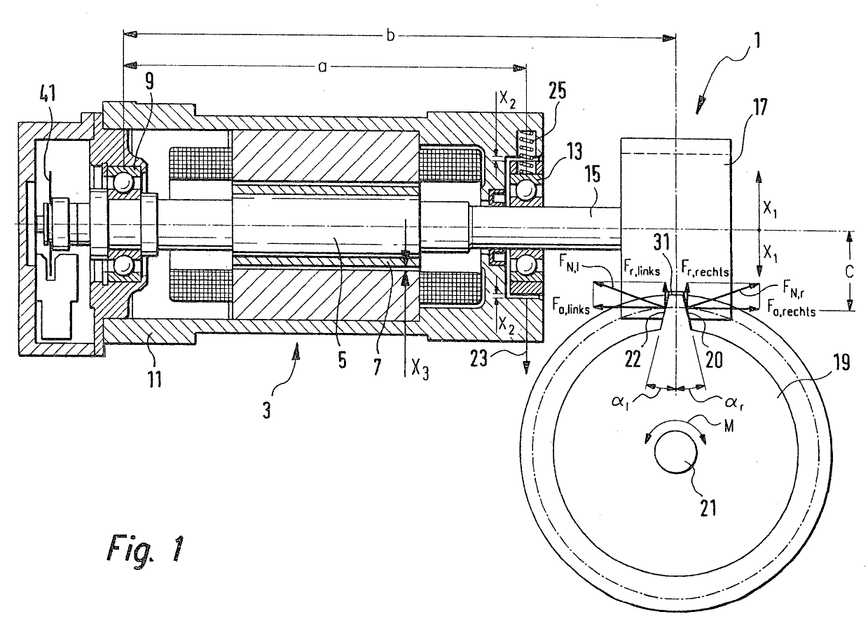

FIG. 1 depicts a first exemplary embodiment of a worm gear 1 according to the invention. The gear 1 comprises an electric motor 3 with a shaft 5 carrying a rotor 7. Shaft 5 is mounted at its one end, by means of a fixed bearing 9 (illustrated only schematically), in a housing 11 of electric motor 3. Disposed at the opposite end of electric motor 3 is a loose bearing 13. A worm 17 is mounted in a rotationally fixed manner (not illustrated) on one end 15 of shaft 5. Said worm 17 thus is cantilevered on shaft 5 and meshes with a worm wheel 19 attached to an output shaft 21. The mounting of the output shaft 21 is not illustrated in FIG. 1. To prevent any play in the teeth between worm 17 and worm wheel 19, shaft 5 can be swiveled on fixed bearing 9 in the direction of the arrows X₁. The swiveling movement of shaft 5 is made possible by the fact that loose bearing 13 is fastened in housing 11 in such fashion that it can be displaced in the direction of worm wheel 19. The direction in which loose bearing 13 plus shaft 5 can be displaced is represented by an arrow 23.

A spring element 25 implemented as a spiral spring presses worm 17 against worm wheel 19 so that the rotary motion of electric motor 3 is transmitted to output shaft 21 without backlash. The spring rate and preload of spring element 25 must be calculated so that regardless of the direction of rotation and the torque of electric motor 3, the forces arising between the tooth flanks of worm 17 and the worm wheel 19 cannot swivel shaft 5 against the spring force of spring element 25. In addition, care should be taken that the spring force of spring element 25 is no greater than necessary, so that the gear according to the invention does not become stiff and the wear unnecessarily high.

To ensure that electric motor 3 operates reliably, the swivel path X₂ of loose bearing 13 must be calculated so that rotor 7 cannot rub against a stator 27 of the electric motor. It should also be made certain that any brushes that are present (not shown) do not impair the operation of the electric motor 3 or angle-of-rotation sensors 41 by swiveling the shaft 5. This means that the gap X₃ between rotor 7 and stator 27 must be calculated so that no contact can occur between rotor 7 and stator 27.

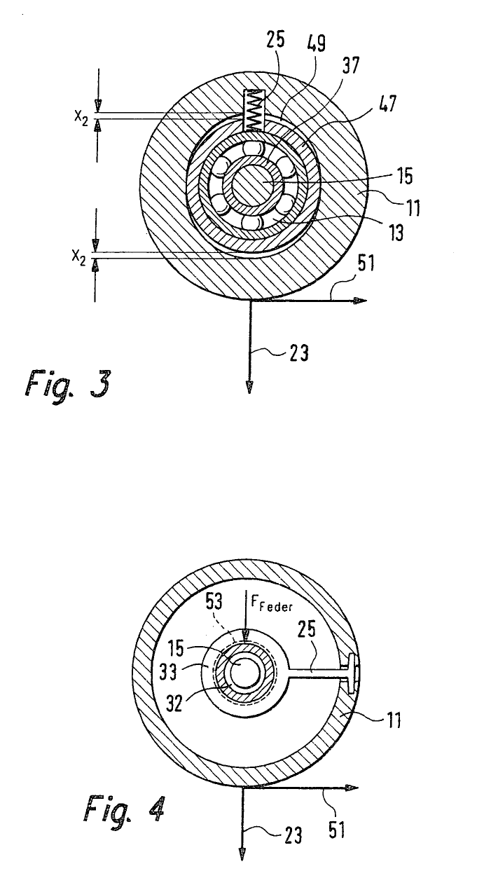

The brushes 29 or the (not illustrated) angle-of-rotation sensors are preferably disposed near fixed bearing 9. The arrangement of loose bearing 13 in housing 11 is described in detail below in FIG. 3.

In FIG. 1, the pressure angle αᵣ of the right tooth flank (20) of a tooth 31 of worm wheel 19 is equal to the pressure angle αₗ of the left tooth flank (22) of tooth 31. Worm gear 1 is implemented as self-inhibiting, i.e., worm wheel 19 cannot rotate when electric motor 3 is switched off. The self-inhibition can be realized or improved by suitable selection of the lead angle (not shown) of worm 17 and a high friction coefficient.

When worm 17 transmits a torque to worm wheel 19, a radial force Fᵣ arises at worm 17. This radial force Fᵣ counteracts the spring force F_{spring} of spring element 25. In addition, the transmission of the torque from worm 17 to worm wheel 19 also produces an axial force F_{A}. This axial force F_{A} changes direction according to the direction of rotation. The spring element 25 must be dimensioned so that the clamping torque
F_{spring}×a
of spring element 25 is greater than the torque
F_{R}×b F_{A}×c.

When a torque M is transmitted to worm wheel 19 via output shaft 21, the following torque balance transpires with respect to the teeth of worm 17 and a tooth 31 of worm wheel 19:

Case 1: The Torque M Acts Counterclockwise (Mathematically Positive):
ΣM=F_{a,r}×c−F_{spring}×a+F_{r,r}×b=0
where:
F_{N,r}: normal force between the right tooth flank 20 of tooth 31 and the worm 17
F_{a,r}: axial component of F_{N,r}
F_{r,r}: radial component of F_{N,r}
a, b, c: length of the effective lever arm
   Case 2: The Torque M Acts Clockwise (Mathematically Negative):
   ΣM=−F_{a,l}×c−F_{spring}×a+F_{r,r}×b=0
   where:
F_{N,l}: normal force between the left tooth flank 22 of tooth 31 and the worm 17
F_{a,l}: axial component of F_{N,l}
F_{r,l}: radial component of F_{N,l}
a, b, c: length of the effective lever arm

Due to the different signs of F_{a,r} and F_{a,l}, the self-inhibition of the worm gear 1 illustrated in FIG. 1 is dependent on the direction of rotation. This effect is undesirable, for example, when the worm gear 1 is used in a servo unit of an electric servo steering system, in a rack-and-pinion steering gear, in a steering actuator, in a speed modulation gear and/or as the steering actuator of a steer-by-wire steering system.

Symmetrical behavior can be achieved for worm gear 1 if the pressure angle αᵣ of right tooth flank 20 and the pressure angle αₗ of left tooth flank 22 of tooth 31 are selected as different.

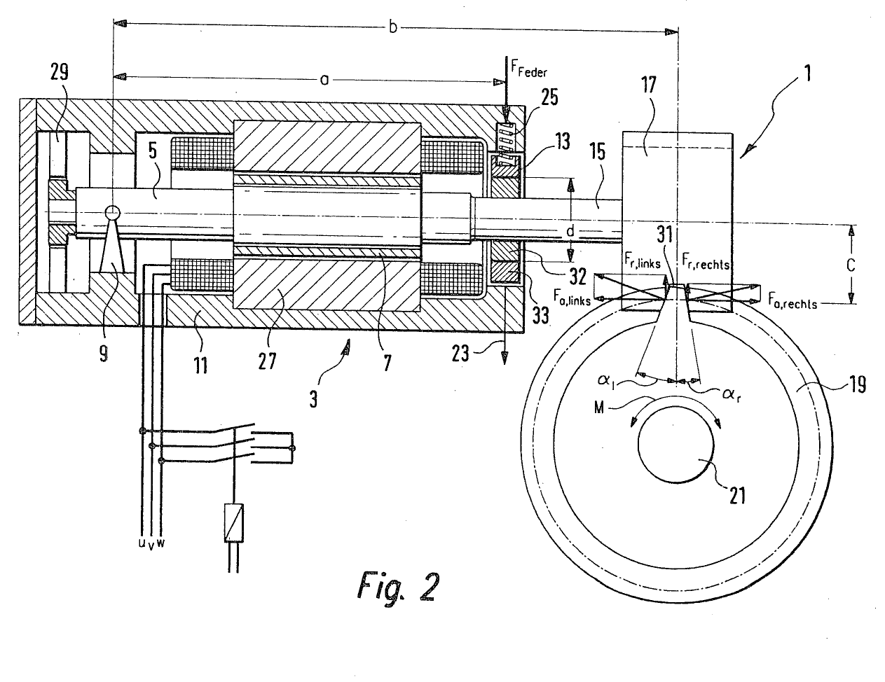

An exemplary embodiment of a worm gear 1 according to the invention is illustrated schematically in FIG. 2. Like components have been assigned the same reference numerals, and the statements made in reference to FIG. 1 apply correspondingly here.

In the toothing illustrated in FIG. 2, the pressure angle αᵣ of right tooth flank 20 is smaller than the pressure angle αₗ of left tooth flank 22 of tooth 31. Worm gear 1 can be made to behave independently of the angle of rotation by a suitable choice of the right and left pressure angles αᵣ and αₗ. The length of the lever arms a, b and c and the spring force F_{spring} influence this choice of pressure angles αᵣ and αₗ. The spring force F_{spring} should theoretically be as small as possible to keep friction and wear to a minimum.

The self-inhibition of worm gear 1 can be further improved if the loose bearing 13, as illustrated in FIG. 2, is implemented as a plain or sleeve bearing. The plain bearing comprises a sleeve 32, which is connected to shaft end 15, and a bearing shell 33, which is arranged in the housing so as to be displaceable in the direction of arrow 23. Spring element 25 exerts a force F_{spring} on bearing shell 33 to ensure the desired freedom from backlash. The arrangement in housing 11 of loose bearing 13 implemented as a plain bearing is described in detail below in FIG. 4. Sleeve 32 can also extend over the entire shaft end 15 and the worm wheel can be connected to sleeve 32. This embodiment is not illustrated.

When the loose bearing is implemented as a plain bearing and shaft 5 is not rotating, sliding friction acts between sleeve 32 and bearing shell 33. The static friction coefficient μ_{static} is greater than the sliding friction coefficient μ_{sliding}, which is the main determinant of the frictional resistance that develops when shaft 5 is rotating. This effect further improves the self-inhibition of the worm gear 1 according to the invention without causing any notable disadvantages in terms of the driving of worm gear 1 by electric motor 3.

This effect can be enhanced by choosing a suitable lubricant for the teeth of worm gear 1 and the plain bearing. The lubricant should have a low sliding friction coefficient μ_{sliding} and should unite sleeve 32 with bearing shell 33 and worm 17 with worm wheel 19 as firmly as possible when the shaft 5 is idle.

Should the self-inhibition of worm gear 1 prove inadequate in extreme, exceptional cases and the electric motor be driven via the worm, this rotary motion is detected by angle-of-rotation sensor 41 (see FIG. 1; not illustrated in FIG. 2). A control unit, not shown, can drive electric motor 3 in such a way that the electric motor returns to its original position and a countertorque is developed by electric motor 3, thereby locking worm gear 1. This locking is termed “active locking” in the context of the invention.

Alternatively to this active locking, so-called electromotive force can be used to effect the so-called passive locking of worm gear 1, which will be explained below with reference to FIG. 2.

The three phases u, v and w of the electric motor 3 are illustrated symbolically in FIG. 2. When electric motor 3 is not supposed to be turning, according to the prior art the three phases u, v and w are switched off. In this case, only the self-inhibition of worm gear 1 ensures that a torque M introduced into worm gear 1 by worm wheel 19 does not cause a rotational movement of electric motor 3. Should the self-inhibition fail in extreme cases, according to the invention by short-circuiting at least two phases u, v or w and disconnecting electric motor 3 from the supply voltage (not shown), the electromotive force of electric motor 3 can be used to lock the gear. If the electric motor is short-circuited and is being driven by the worm gear, then the motor, in generator mode, develops a braking torque. This braking torque increases linearly with the rotation speed of the electric motor. Even at very low motor rotation speeds a braking torque is established that is in equilibrium with torque M or with the torque introduced in the shaft 5 of electric motor 3 via worm 17. The short-circuiting of phases u, v and/or w can be executed via a relay or by FET semiconductor elements.

If, in this condition, a steering operation is performed at the steering wheel and the self-inhibition of worm gear 1 simultaneously fails, the electric motor turns at a lower rotation speed in generator mode. This rotation speed is so low that the steering operation is not threatened by it and the steering input is transmitted reliably from the steering wheel to the steered wheels.

Alternatively, should the self-inhibition of electric motor 3 fail, a control unit, not illustrated, can drive the system so that rotor 7 does not rotate and a countertorque to torque M acting on worm wheel 19 is developed. An angle-of-rotation sensor 41, as illustrated in FIG. 1, must be present for this purpose. However, an angle-of-rotation sensor is usually present with worm gears for vehicle steering systems according to the invention, since the position of the steering gear must be monitored.

It is expressly pointed out that the asymmetrical toothing according to the invention and the circuitry of the electric motor 3 can also be used in combination with the worm gear 1 described in FIG. 1.

FIG. 3 is a sectional diagram of the loose bearing 13 from FIG. 1. The shaft end 15 is mounted by means of a ball bearing 37 in a support ring 47. Support ring 47 is in turn received in a slot 49 in housing 11. Slot 49 is dimensioned so that support ring 47 can be displaced in the direction of arrow 23 by twice the length X₂. That is, the swivel stroke X₂ is determined by the length of slot 49 in the radial direction. Spring element 25 acts either directly on the outer ring of ball bearing 37 or indirectly via support ring 47 on shaft end 15. In the tangential direction, which is indicated here by an arrow 51, slot 49 is dimensioned so that support ring 47 fits in slot 49 without play. Spring element 25 simultaneously serves as an anti-twist device to keep support ring 47 from rotating in slot 49. Other embodiments that are free of play in the tangential direction and enable support ring 47 to be displaced by twice the amount of X₂ are also to be placed under protection.

FIG. 4 is a sectional diagram of a further exemplary embodiment of a loose bearing 13 according to the invention as shown in FIG. 2. Shaft end 15 is pressed together with a sleeve 32. Sleeve 32 is able to rotate in bearing shell 33. In this exemplary embodiment, spring element 25 is implemented as a leaf spring and is connected to housing 11 in such a way as to exert the desired spring force F_{spring} on worm 17 (see FIG. 2). Bearing shell 33 and spring element 25 are implemented as one piece in the exemplary embodiment shown. The limit stop—e.g. in the event of high tooth forces—takes the form of a bore 53, represented by a dashed line, in motor housing 11.

The connection between spring element 25 and housing 11 is designed so that the spring force F_{spring} and the forces acting in the tangential direction (see arrow 51) can be reliably transmitted by spring element 25. This exemplary embodiment of a displaceable loose bearing is especially favorable with regard to production, installation and operation. In addition, this arrangement is completely free of play in the tangential direction (see arrow 51).

The invention and its applicability are not limited to worm gears according to the exemplary embodiments, but can also be used successfully with other types of gears.

All the features described in the description, the drawing and the claims can be essential to the invention both singly and in any combination.

1. A worm gear for a vehicle steering system, said worm gear comprising a shaft swivably mounted for swiveling in the radial direction, a worm disposed in a rotationally fixed manner on said shaft, and a worm wheel meshing with said worm, said worm and said worm wheel preloaded in the radial direction, said worm wheel having teeth, each said tooth having right and left tooth flanks which are inclined at respective pressure angles, the pressure angle of the right tooth flank and the pressure angle of the left tooth flank being different from each other so that the normal force between said worm and said worm wheel is independent of the direction of rotation of a torque exerted on said worm by said worm wheel.

2. The worm gear according to claim 1, further comprising a housing, said shaft is mounted in said housing by means of a fixed bearing and at least one loose bearing, said loose bearing displaceable in the radial direction in said housing.

3. The worm gear according to claim 2, wherein said housing comprises a slot for receiving said loose bearing, the longitudinal axis of said slot extending in the radial direction.

4. The worm gear according to claim 2, further comprising a support ring, said loose bearing bearing against said housing via said support ring.

5. The worm gear according to claim 2, further comprising a spring element disposed between one of said loose bearing and said housing and between said support ring and said housing.

6. The worm gear according to claim 5, wherein said spring element is one of a spiral spring and a plate spring.

7. The worm gear according to claim 2, further comprising an anti-twist device disposed between one of said loose bearing and said housing and between said support ring and said housing.

8. The worm gear according to claim 2, further comprising a leaf spring, said loose bearing connected via said leaf spring to said housing said leaf spring extending perpendicularly to the longitudinal axis of said shaft and perpendicularly to the direction in which said loose bearing is displaceable between said housing and said loose bearing.

9. The worm gear according to claim 1, wherein said shaft is the rotor shaft of an electric motor.

10. The worm gear according to claim 1, wherein said worm is cantilevered on said shaft.

11. The worm gear according to claim 1, wherein said shaft is mounted in said housing by means of one of sleeve bearings and rolling bearings.

12. A gear assembly for a vehicle steering system comprising the worm gear of claim 1, an electric motor having three phases, and an output shaft wherein at least two of said phases of said electric motor are short-circuited and said electric motor is disconnected from a voltage supply when said electric motor is selected not to turn.

13. The worm gear according to claim 12, wherein said short-circuiting of at least two phases of said electric motor is effected by means of one of a relay and by means of FET semiconductor elements.

14. A servo unit for use in one of an electric servo steering system, a rack-and-pinion steering gear, a steering actuator, a speed modulation gear and steering actuator of a steer-by-wire steering system, said servo unit comprising the worm gear of claim 1.
